(19) United States
(12) Patent Application Publication
(10) Pub. No.: US 2015/0159349 A1
(43) Pub. Date: Jun. 11, 2015

(54) LUBRICANT TESTING ASSEMBLY

(71) Applicant: Caterpillar Inc., Peoria, IL (US)

(72) Inventor: Gerry L. Horton, East Peoria, IL (US)

(73) Assignee: Caterpillar Inc., Peoria, IL (US)

(21) Appl. No.: 14/622,950

(22) Filed: Feb. 16, 2015

(51) Int. Cl. E02F 9/26; B62D 55/092; E02F 9/02; B62D 55/06

(52) U.S. Cl. CPC E02F 9/267; B62D 55/06; B62D 55/092; E02F 9/02

(57) ABSTRACT

A mobile machine includes a thermal imaging device mounted proximate to a plurality of lubricated track link joints of a track assembly. The thermal imaging device is configured to capture a thermal image associated with the lubricated track link joints contained within a field of view. The mobile machine further includes a testing module operatively coupled to the thermal imaging device. The testing module is configured to receive the thermal image associated with the lubricated track link joints. The testing module obtains a thermal signature associated with the lubricated track link joints based on the thermal image. The testing module further compares the thermal signature with a pre-determined temperature threshold. The testing module further identifies a failure condition if the thermal signature exceeds the pre-determined temperature threshold.

### TECHNICAL FIELD

The present disclosure relates to a lubricant testing assembly for an undercarriage system, and more particularly to the lubricant testing assembly for a track link joint of the undercarriage system.

### BACKGROUND

A mobile machine may be used to perform various types of work on different worksites, such as, a construction site, a demolition site, a mining site, or a landfill site. For example, a bulldozer may be used to push soil and rock on a construction site. Operation of the mobile machine may result in wear or damage to various components, including components of an undercarriage assembly of the mobile machine, such as, track links and roller assemblies. The track links and the roller assemblies are provided with lubrication to lessen friction caused due to rubbing among internal and external components.

For example, as a track assembly operates, an external surface of the track link comes into contact with other components of the track assembly, machine, and/or outside materials (e.g., the ground), and the internal components of the track link rub against each other during operation of the machine. With time and use, the lubricant associated with the internal components may deteriorate due to leakage at the track link Such a scenario may lead improper lubrication and increased friction among the rubbing components of the track link, in turn causing wear and tear or failure of the track links, thereby causing an increase in machine downtime and decrease in overall system efficiency.

Therefore, the track assembly is periodically inspected for lubrication, wear, and tear of components, assembled therein. To improve the life of these components, it is desired to have prognostic, in-situ, or real-time tool to analyze the health condition of these components.

US Patent Publication 2014/0229120 describes a system and method for determining a health condition of wellsite equipment. The method includes thermally analyzing at least a portion of one of the wellsite equipment units with a thermal imaging device capable of detecting infrared light to determine a temperature of the analyzed portion of the wellsite equipment unit. The temperature of the analyzed portion of the wellsite equipment unit may be used to indicate the health condition of the wellsite equipment unit. However, the patent publication does not disclose monitoring of lubrication associated with track links of an undercarriage system.

### SUMMARY OF THE DISCLOSURE

In one aspect of the present disclosure, a mobile machine is disclosed. The mobile machine includes an undercarriage system including a track assembly configured to travel around a plurality of rotating components. The track assembly includes a plurality of lubricated track link joints. The mobile machine further includes a thermal imaging device mounted on the machine proximate to the track assembly of the undercarriage system. The thermal imaging device is configured to capture a thermal image associated with each of the plurality of lubricated track link joints contained within a field of view. The mobile machine also includes a testing module operatively coupled to the thermal imaging device. The testing module is configured to receive the thermal image associated with the lubricated track link joints. The testing module obtains a thermal signature associated with the lubricated track link joints based on the thermal image. The testing module further compares the thermal signature associated with the lubricated track link joints with a pre-determined temperature threshold. The testing module further identifies a failure condition if the thermal signature exceeds the pre-determined temperature threshold.

Other features and aspects of this disclosure will be apparent from the following description and the accompanying drawings.

### BRIEF DESCRIPTION OF THE DRAWINGS

FIG. 1 is a side view of an exemplary machine having an undercarriage system, according to one embodiment of the present disclosure;

FIG. 2 is a sectional view of a track link joint of the undercarriage system of the machine of FIG. 1, according to one embodiment of the present disclosure;

FIG. 3 is an enlarged view of an encircled portion 3-3 of FIG. 1, according to one embodiment of the present disclosure; and

FIG. 4 is a block diagram of a lubricant testing assembly, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

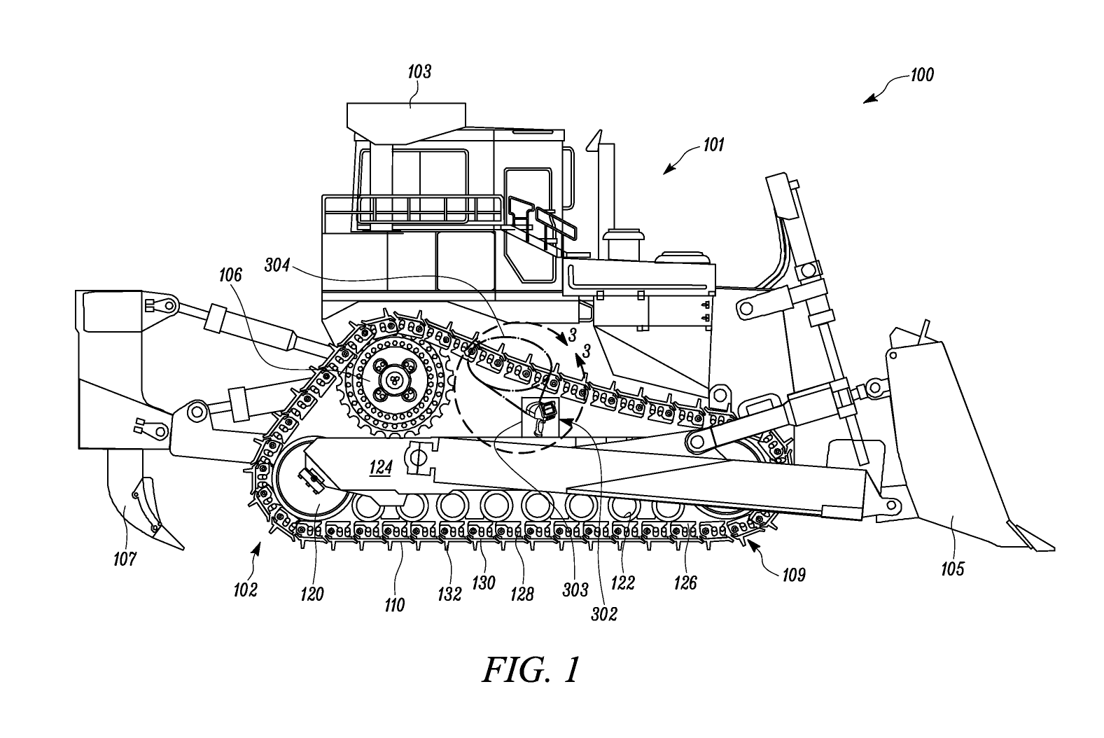

FIG. 1 illustrates an exemplary mobile machine 100. In the illustrated embodiment, the mobile machine 100 is a track-type tractor. However, the present disclosure may be embodied in any type of machine having an undercarriage, for example, skid steers, dozers, excavators, backhoes, track loaders, and the like. The mobile machine 100 includes an upper body portion 101 supported by an undercarriage system 102. The upper body portion 101 includes an operator cabin 103. Further, a power source (not shown), such as an engine, may be disposed in the upper body portion 101. The power source may be configured to generate power to propel the mobile machine 100, and operate a first implement 105 and a second implement 107 of the mobile machine 100. In the illustrated embodiment, the first and second implements 105, 107 are a blade assembly and a ripper, respectively. However, the concepts of the present disclosure may be embodied in any type of machine having the undercarriage system 102, for example, skid steers, dozers, excavators, backhoes, track loaders, and the like.

The undercarriage system 102 may include a pair of track assemblies 109 (only one shown) on opposing sides of the mobile machine 100. The track assembly 109 is configured to travel around multiple rotating components. The rotating components include a track 110, a drive sprocket 106, at least one idler 120, track rollers 122, and a frame assembly 124. The track 110 forms a continuous structure operatively coupled to the drive sprocket 106, the idlers 120, and the track rollers 122. Further, the power source of the mobile machine 100 may transmit power to the drive sprocket 106 via a driving mechanism. The driving mechanism may include a mechanical drive, a hydraulic drive, an electric drive, or a combination thereof.

The frame assembly 124 may include multiple members (not shown) movable longitudinally relative to one another. During operation, a relative movement between the members of the frame assembly 124 may move the idlers 120 relative to one another. Further, rotation of the drive sprocket 106 may cause the drive the track 110 to move around the drive sprocket 106, the idlers 120, and the track rollers 122 to engage the ground surface, and thereby propel the mobile machine 100. The drive sprocket 106 is driven in different directions to propel the mobile machine 100 in forward or reverse directions. Further, the mobile machine 100 is steered by providing differential power to the drive sprockets 106 of the corresponding track assemblies 109.

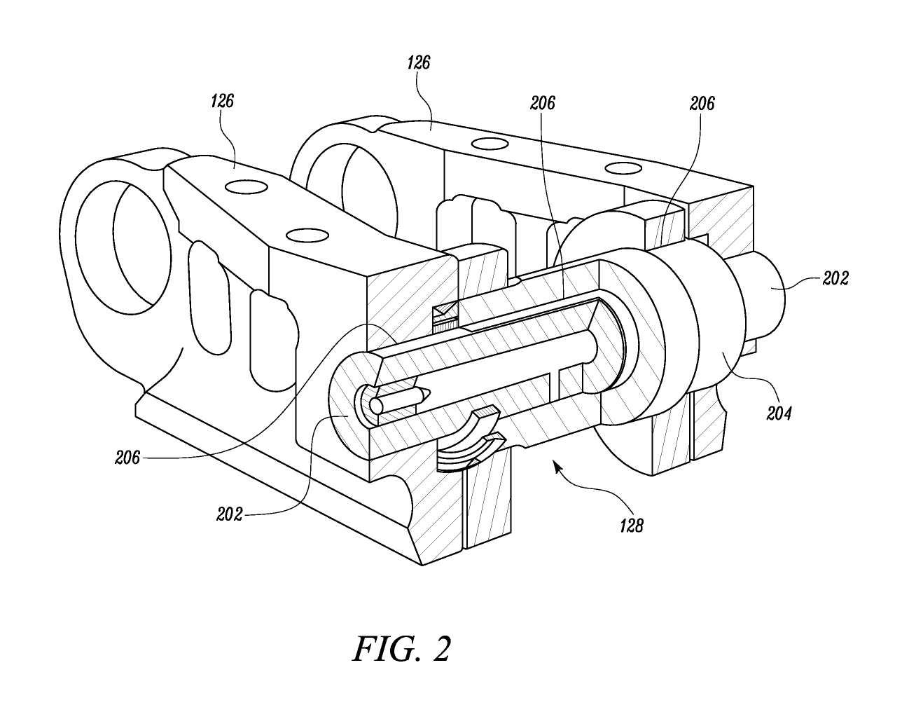

The track 110 includes a number of lubricated track link joints 126 interconnected to each other. Referring to FIGS. 1 and 2, adjacent lubricated track link joints 126 are rotatably coupled together via a track pin assembly 128. The track pin assembly 128 engages with teeth of the drive sprocket 106 to drive the track 110 around the drive sprocket 106, the idlers 120, and the track rollers 122.

The track 110 further includes a number of track shoes 130 secured to the lubricated track link joints 126. Each track shoe 130 has a connecting portion configured to be secured to one or more of the lubricated track link joints 126 and a ground engaging portion 132 configured to contact the ground. The ground engaging portion 132 include one or more portions (e.g., grouser bars) that provide increased traction between the track shoes 130 and the ground. It should be understood that the various components of the undercarriage system 102 described above are purely exemplary and not intended to be limiting of the present disclosure.

Referring to FIG. 2, the internal components of the track pin assembly 128 includes a pin 202 and a bushing 204. The track pin assembly 128 is pivotally coupled to the adjacent lubricated track link joints 126. The pin 202 and the bushing 204 of the track pin assembly 128 as received with the lubricated track link joints 126 define multiple contacting surfaces 206. The contacting surfaces 206 include rotating, sliding, or constrained rotating or sliding surfaces. Such contacting surfaces 206 are provided with suitable lubricant to enhance lubricity among the contacting surfaces 206 for smooth operation, and to further achieve reduced wear and tear in view of frictional contact.

However, with time and use, the lubricant may leak from the track pin assembly 128. Such reduction in the volume of the lubricant may increase friction among the contacting surfaces 206, and may further lead to damage the internal components because of wear and tear of the contacting surfaces 206.

Referring to FIGS. 1, 2 and 3, the present disclosure relates to a lubricant testing assembly 302 provided in association with the undercarriage system 102 of the mobile machine 100. The lubricant testing assembly 302 is configured to monitor a condition of the lubricant associated with the lubricated track link joints 126, as will be explained hereinafter in detail. In context of the present disclosure, as shown in FIG. 1, the lubricant testing assembly 302 is mounted on the mobile machine 100 in association with the undercarriage system 102. The lubricant testing assembly 302 is provided proximate to the track assembly 109 of the undercarriage system 102. As shown, the lubricant testing assembly 302 may be mounted on the machine within the undercarriage system 102 within a protective housing 303. The protective housing 303 provides structural support and strength to the lubricant testing assembly 302 during operation of the mobile machine 100, and also safeguards the lubricant testing assembly 302 against external harsh environment. The lubricant testing assembly 302 is configured to monitor condition of lubricant associated with the lubricated track link joints 126 contained within a field of view 304 of the lubricant testing assembly 302.

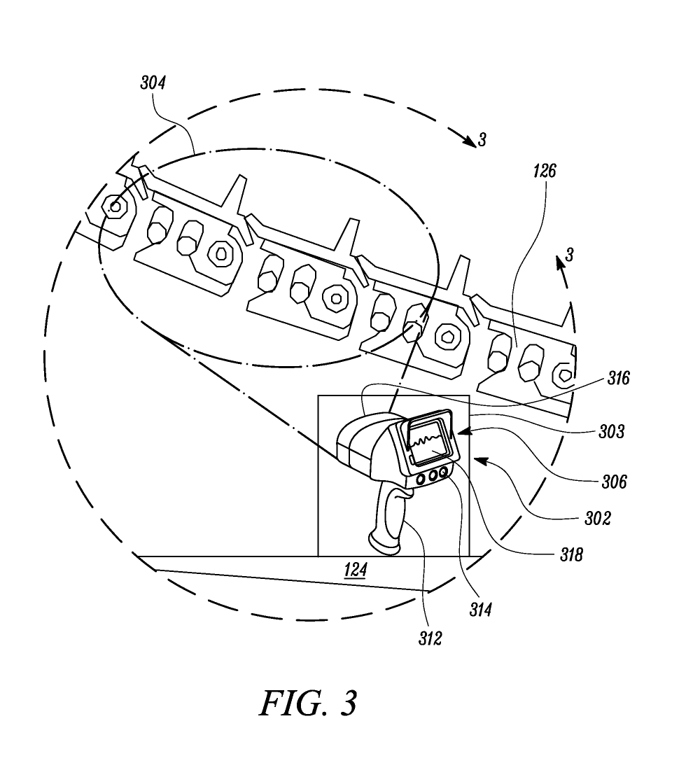

Referring to FIG. 3, a zoomed view of a portion of the undercarriage system 102 along with the lubricant testing assembly 302 is provided. The lubricant testing assembly 302 includes a thermal imaging device 306. The thermal imaging device 306 may be any thermal sensing device known in the art having a defined field of view 304. The field of view 304 may be defined as portion of the undercarriage system 102 as captured by a scanning portion 316 of the thermal imaging device 306. The thermal imaging device 306 includes a base portion 312 about which it is positioned with respect to the undercarriage system 102 such that the lubricated track link joints 126 lie within the field of view 304 of the thermal imaging device 306. More particularly, the thermal imaging device 306 detects infrared electromagnetic radiation emitted from the lubricated track link joints 126 that lie within the filed of view 304 of the thermal imaging device 306.

In an example, the thermal imaging device 306 may be ratio, or dual colored, or two colored pyrometers configured to monitor intensity of radiation emitted at multiple wavelengths. The thermal imaging device 306 enables non-contact temperature measurements on the lubricated track link joints 126. Although not specifically shown, the thermal imaging device 306 may include a scanning and detecting device that is sensitive to predefined wavelengths appropriate for temperatures achieved because of friction among the contacting surfaces 206. In an embodiment, the thermal imaging device 306 is configured to be operable by one or more buttons 314 to capture a thermal image or thermal signature associated with the lubricated track link joints 126 contained within the field of view 304. The thermal signature as captured by the thermal imaging device 306 is indicative of a thermal gradient among the contacting surfaces 206. The thermal image or the thermal signature as captured will be reflected on a screen 318 of the thermal imaging device 306. The design of the thermal imaging device 306 shown in the accompanying figures is exemplary and does not limit the scope of the present disclosure. In one embodiment, an increase in temperature of the contacting surfaces 206 at the lubricated track link joints 126 is attributed to failure of the lubricated track link joints 126 due to leakage of the lubricant thereof.

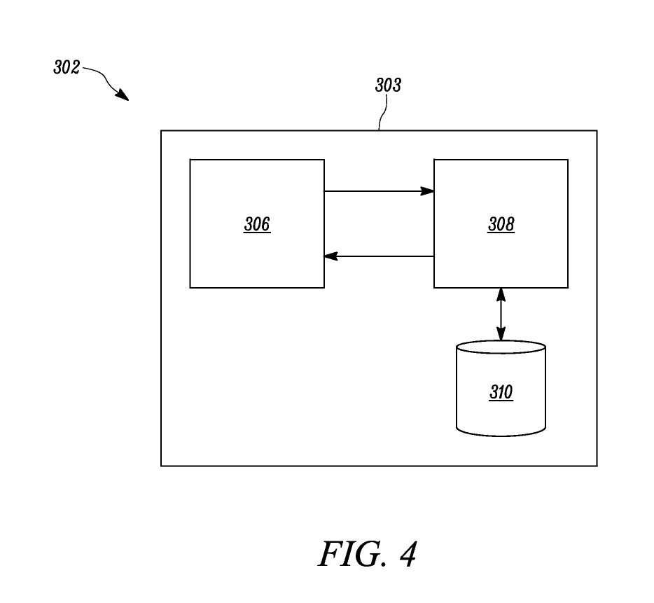

Referring to FIG. 4, a block diagram depicting the lubricant testing assembly 302 is provided. The lubricant testing assembly 302 further includes a testing module 308. The testing module 308 is operatively coupled to the thermal imaging device 306. The testing module 308 may be any computing system known in the art configured to generate, receive, transmit, and/or modify signals in communication with the thermal imaging device 306. For example, the testing module 308 may include a signal conditioner, an amplifier, a multiplexer, and/or a converter (e.g., an analog-to-digital (A/D) converter or a digital-to-analog (D/A) converter).

The testing module 308 is configured to receive the thermal image captured by the thermal imaging device 306 associated with the lubricated track link joints 126 contained within the field of view 304. The testing module 308 is further configured to obtain the thermal signature associated with the lubricated track link joints 126 based on the thermal image captured by the thermal imaging device 306. The thermal signature is indicative of a change in thermal gradient, i.e. rise in temperature, over a defined period of time associated with the lubricated track link joints 126 during operation of the mobile machine 100. In an embodiment, the thermal signature is indicative of condition of the lubricant provided between the contacting surfaces 206 of the track pin assembly 128 of the lubricated track link joint 126.

The testing module 308 is further configured to compare the thermal signature associated with the lubricated track link joints 126 with a pre-determined temperature threshold. The pre-determined temperature threshold defines a range temperature values associated with the lubricated track link joints 126. The lubricant testing assembly 302 also includes a database 310 in communication with the testing module 308. The database 310 may be any state of the art memory device configured to store data corresponding to the thermal image, thermal signature, and the pre-determined temperature threshold as mentioned in context of the present disclosure. The testing module 308 is configured for querying the database 310 for retrieving and saving data corresponding to the thermal image, thermal signature, and the pre-determined temperature threshold during operation of the mobile machine 100.

In operation, the testing module 308 compares the thermal signature of the lubricated track link joints 126 with the pre-determined threshold temperature and identifies if the thermal signature has exceeded the pre-determined threshold temperature. If the thermal signature of the lubricated track link joints 126 exceeds pre-determined threshold temperature, the testing module 308 identifies a failure condition of the lubricated track link joints 126. The failure condition of the lubricated track link joints 126 is indicative of a dry track link joint or a leaky track link joint, based on leakage of the lubricant from the lubricated track link joints 126. In one embodiment, the testing module 308 may provide a notification to an operator indicative of the failure of the lubricated track link joints 126. For example, the testing module 308 may send command signals to notify the operator via an audio or visual notification through an output device present in the operator cabin 103 of the mobile machine 100.

The lubricant testing assembly 302 may further include a power source (not shown) configured to provide power to the thermal imaging device 306 and the testing module 308. In an embodiment, the power source may include a battery, such as, a coin-cell type battery. In some embodiments, the power source may additionally or alternatively include a motion-based energy source, such as, a vibration-based energy-harvesting system, to power one or more of the components of the lubricant testing assembly 302, and/or may be used to charge a battery of the power source. In yet another embodiment, the power source may include a battery capable of being wirelessly charged (e.g., near-field charging). In this way, the lubricant testing assembly 302 may be embedded along with the undercarriage system 102 while being capable of receiving electrical power from outside, and thus reducing on-board power (e.g., battery) requirements.

It may be contemplated that the lubricant testing assembly 302 may include multiple thermal imaging devices 306 disposed on the corresponding undercarriage components. In an embodiment, the multiple thermal imaging devices 306 may be in communication with a single testing module 308. Alternatively, a separate testing module 308 may be provided for each of the thermal imaging device 306. Further, the orientation and dimensions of the sensing device are not limited to that described herein.

### INDUSTRIAL APPLICABILITY

The industrial applicability of the lubricant testing assembly 302 described herein will be readily appreciated from the foregoing discussion. As described earlier, the lubricant testing assembly 302 includes the thermal imaging device 306 configured to generate the thermal image of components of the undercarriage system 102, for example, the lubricated track link joints 126. The components may also include, for example, but not limited to, the idler 120, the track roller 122, and the track shoe 130. The lubricant testing assembly 302 also includes the testing module 308 operatively coupled to the thermal imaging device 306. The testing module 308 receives the thermal image from the thermal imaging device 306 and further obtains the thermal signature associated with the lubricated track link joints 126. The testing module 308 further compares the thermal signature with the pre-determined threshold temperature to identify the failure condition associated with the lubricated track link joints 126, if the thermal signature exceeds the pre-determined threshold temperature. The failure condition includes at least one of the leak in the lubricated track link joints 126 or dryness in the lubricated track link joints 126.

The lubricant testing assembly 302 may enable real time monitoring of wear of the components of the undercarriage system 102 due to low lubricity. Further, the thermal imaging device 306 disposed around the undercarriage system 102, thereby enabling accurate determination of the condition and characteristics of the lubricant. This may indicate whether components of the undercarriage system 102 require repair and/or replacement. Further, the lubricant testing assembly 302 may provide an alert if the undercarriage system 102 requires immediate attention, thereby preventing any possible failures of the undercarriage system 102.

The testing module 308 further records and monitors the thermal signature of the lubricated track link joints 126 in the field of view 304 of the thermal imaging device 306 to identify good parameters or baselines of the track 110 in similar conditions or in-comparison to the other joints in the track 110 on the opposite side of the same mobile machine 100. The objective of the testing module 308 is to detect joints under load and working temperature that exhibit the thermal signatures above all the other joints. This would allow for early joint preventative maintenance, and further prevent machine down condition due to joint failure. The early joint failure detection would allow for a simple and cost effective solution to fix the failure condition, like filling the dry or leaky joint or get the mobile machine 100 serviced before significant damage to the joint occurs. Further the lubricant testing assembly 302 described herein is a simple configurable system that can be easily retrofitted on existing machines without major modifications and cost inclusions.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mobile machine comprising:
an undercarriage system including a track assembly configured to travel around a plurality of rotating components, the track assembly having a plurality of lubricated track link joints;
a thermal imaging device mounted on the machine proximate to the track assembly of the undercarriage system, the thermal imaging device configured to capture a thermal image associated with each of the plurality of lubricated track link joints contained within a field of view thereof; and
a testing module operatively coupled to the thermal imaging device, the testing module configured to:
receive the thermal image associated with each of the plurality of lubricated track link joints;
obtain a thermal signature associated with each of the plurality of lubricated track link joints based on the thermal image;
compare the thermal signature associated with each of the plurality of lubricated track link joints with a pre-determined temperature threshold; and
identify a failure condition if the thermal signature exceeds the pre-determined temperature threshold.
